(19) United States
(12) Patent Application Publication
(10) Pub. No.: US 2010/0169564 A1
(43) Pub. Date: Jul. 1, 2010

(54) APPARATUS AND METHOD FOR ACCESSING DATA

(75) Inventor: Han-Liang Chou, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: SUNPLUS TECHNOLOGY CO., LTD., Hsinchu (TW)

(21) Appl. No.: 12/648,305

(22) Filed: Dec. 29, 2009

(30) Foreign Application Priority Data
Dec. 29, 2008 (TW) 97151230

(51) Int. Cl. G06F 12/08

(52) U.S. Cl. 711/111; 711/E12.019

(57) ABSTRACT

A data access apparatus and method are provided. The data access apparatus includes a first memory, a second memory and a memory controller. The first memory and the second memory have the same memory capacity for respectively storing the neighbor data of an image. The memory controller is coupled to the first memory and the second memory for providing shared control signals and shared address signals, and further providing a plurality of first address signals and a plurality of second address signals to the first memory and the second memory respectively. The memory controller dynamically accesses the first memory and the second memory by different column address strobe (CAS) signal of the shared control signals, the first address signals and the second address signals.

### CROSS-REFERENCE TO RELATED APPLICATION

This application claims the priority benefit of Taiwan application serial No. 97151230, filed on Dec. 29, 2008. The entirety of the above-mentioned patent application is hereby incorporated by reference herein and made a part of this specification.

### BACKGROUND OF THE INVENTION

1. Field of the Invention

The present invention relates to a data access technology, more particularly, to a data access apparatus and method capable of saving the memory bandwidth and reducing the memory access time.

2. Description of the Related Art

With the rapid and staggering progress of video codec technology, the requirements for the memory bandwidth are getting higher and higher. In order to supply enough memory bandwidth, the width of the data bus for the external memories is generally increased. For current technology, two memories would generally be integrated to increase the width of the data bus. Take DDR for example, two 16-bit DDRs would be served as one memory to use, and these two DDRs share all of control signals (for example, RAS, CAS and WE) and address signals (Addr[12:0]) as shown in FIG. 1. Accordingly, such manner cooperating with double transition clocking technology would be let the memory bandwidth to achieve 64-bit/cycle.

As everyone knows, that is, the motion compensation technology would be generally applied during process of decoding the digital images. In general, the motion compensation technology reads the data of the external memories irregularly, and it would determine to catch the start position of the past image according to the motion vector. However, a lot of the memory bandwidth would be consumed when the start position does not align with the width of the data bus for the external memories.

Take H.264 video codec specification for example, the motion compensation technology often catches 13-byte data in horizontal lines during the process of decoding the digital images, and the width of the data bus for the external memories is 64-bit at this time. In the worse case, the memory controller should read 24-byte data in the external memories so as to obtain the necessary 13-byte data in horizontal lines when the start position of the motion vector does not align with the width of the data bus for the external memories. Then, the memory bandwidth would be consumed mostly.

In summary, even though the memory bandwidth could be promoted by increasing the width of the data bus for the external memories, and such solution brings of great benefit for regularly accessing the data of the external memories. But for the motion compensation technology which is accessing the data of the external memories irregularly, the memory bandwidth would be mostly wasted. Accordingly, it still leaves much room for improvement.

### SUMMARY OF THE INVENTION

The present invention is directed to a data access apparatus and method which would be cooperated with the current video codec technology to further achieve the advantage of saving the memory bandwidth.

The present invention provides a data access apparatus for accessing data of an image. The data access apparatus includes a first memory, a second memory and a memory controller. The memory capacity of the first memory is equal to the memory capacity of the second memory, and the neighbor data of the image are respectively stored in the first memory and the second memory. The memory controller is coupled to the first memory and the second memory, and used for providing shared control signals and shared address signals to the first memory and the second memory, and respectively providing a plurality of first address signals and a plurality of second address signals to the first memory and the second memory. When the data access apparatus adopts a motion compensation technology to access the first memory and the second memory during a process of decoding the image, and a start position of a motion vector does not align with the width of the data bus of the first memory and the second memory, the data access apparatus sends different column address strobe (CAS) signals from the control signals, the first address signals and the second address signals through the memory controller to dynamically access the first memory and the second memory.

The present invention provides a data access method for accessing data from an image. The method is applied to a data access system. The data access method includes providing a first memory and a second memory both having the same memory capacity to the data access system; storing the neighbor data of the image to the first memory and the second memory respectively; providing shared control signals and shared address signals to the first memory and the second memory, and respectively providing a plurality of first address signals and a plurality of second address signals to the first memory and the second memory through a memory controller of the data access system; and when the data access system adopts a motion compensation technology to access the first memory and the second memory during a process of decoding the image, and a start position of a motion vector does not align with the width of the data bus of the first memory and the second memory, sending different column address strobe (CAS) signals of the shared control signals, the first address signals and the second address signals through the memory controller to dynamically access the first memory and the second memory.

According to an embodiment of the present invention, the number of the first address signals is equal to the number of the second address signals.

According to an embodiment of the present invention, the number of the first address signals and the number of the second address signals determine that the memory controller accesses a dynamic range of the first memory and the second memory during a clock cycle.

According to an embodiment of the present invention, the memory controller accesses the data with different addresses in the first memory and the second memory according to the dynamic range.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a structure diagram of the conventional memory controller accessing two 16-bit DDRs.

FIG. 2 is block diagram of a data access apparatus according to an embodiment of the present invention.

FIG. 3 is a diagram of a data access apparatus accessing a single line in a first memory and a second memory.

FIGS. 4, 5 and 6 are a diagram of a data access apparatus accessing multi-columns and multi-rows in a first memory and a second memory.

FIG. 7 is a flow chart of a data access method according to an embodiment of the present invention.

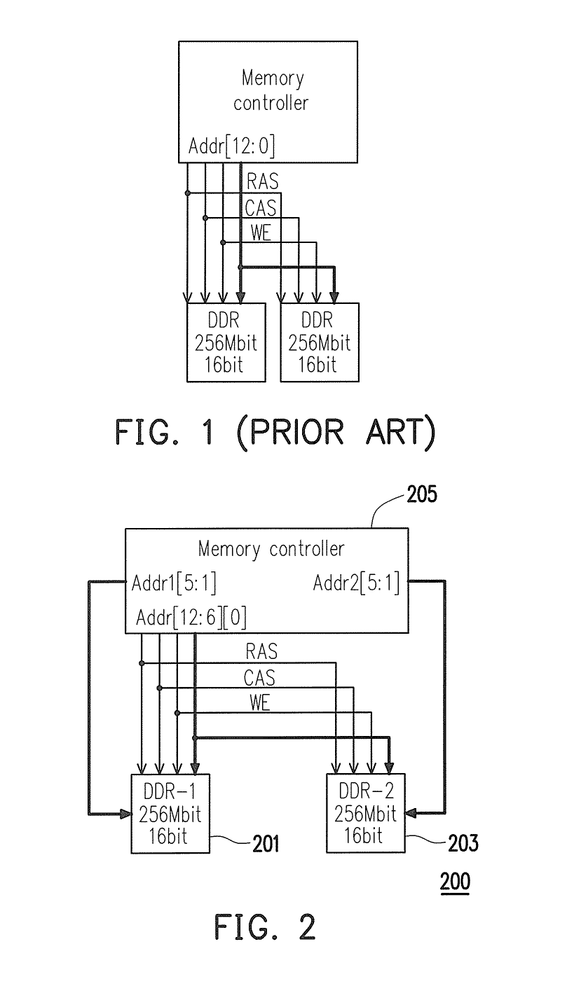

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 2 is block diagram of a data access apparatus 200 according to an embodiment of the present invention. Referring to FIG. 2, the data access apparatus 200 includes a first memory 201, a second memory 203 and a memory controller 205. In the present embodiment, the memory capacity of the first memory 201 is equal to the memory capacity of the second memory 203. The first memory 201 and the second memory 203 may, for example, the SDRAM, DDR, DDR2, or DDR3. As shown in FIG. 2, the first memory 201 and the second memory 203 are, for example, the DDRs having the memory capacity of 256 Mbit with 16-bit data bus, but not limited thereto.

The memory controller 205 is coupled to the first memory 201 and the second memory 203. The memory controller 205 is used for providing the shared control signals such as the row address strobe (RAS) signal, the column address strobe (CAS) signal and the write enable (WE) signal etc. to the first memory 201 and the second memory 203, and respectively providing a plurality of first address signals Addr1[5:1] and a plurality of second address signals Addr2[5:1] to the first memory 201 and the second memory 203, so as to dynamically access the first memory 201 and the second memory 203. In the present embodiment, if the memory controller 205 has N address pins, the 1^{st} through (N−1)^{th} address pins could be separated to the different memories, and at least one address pin is shared to the different memories. Accordingly, the present embodiment is different from the prior art which would or would not fully share all of the address pins. Take the DDR having the memory capacity of 256 Mbit with 16-bit data bus for example, the address pins Addr[5:1] could be separated to two different DDRs, and the rest address pins Addr[12:6][0] are still shared by these two DDRs, such that can save the number of pads of the memory controller. The number of the first address signals Addr1[5:1] is equal to the number of the second address signals Addr2[5:1], and the number of the first address signals Addr1[5:1] and the number of the second address signals Addr2[5:1] are determined by the requirement of practical design. A dynamic cycle about the memory controller 205 accesses the first memory 201 and the second memory 203 during a clock cycle is determined by the number of the first address signals Addr1[5:1] and the second address signals Addr2[5:1]. Accordingly, the memory controller 205 would arbitrarily access the data with different addresses in the first memory 201 and the second memory 203 according to the dynamic range.

In the present embodiment, since the number of the first address signals Addr1[5:1] and the number of the second address signals Addr2[5:1] is five, so that the dynamic range of the first memory 201 and the second memory 203 accessed by the memory controller 205 during a clock cycle is 256-byte (2⁵*8). In addition, if the number of the first address signals Addr1 and the number of the second address signals Addr2 is six, then the dynamic range of the first memory 201 and the second memory 203 accessed by the memory controller 205 during a clock cycle is 512-byte (2⁶*8), and so on.

According to the present embodiment, the first memory 201 and the second memory 203 may respectively have its own address signals (i.e. the first address signals Addr1[5:1] and the second address signals Addr2[5:1]), and may have the shared address signals Addr[12:6][0] and the shared control signals (i.e. RAS, CAS, WE) in common. Accordingly, the structures between the present embodiment and the prior art are obviously different because the prior art should share all of the control signals (i.e. RAS, CAS, WE) and the address signals (Addr[12:0]).

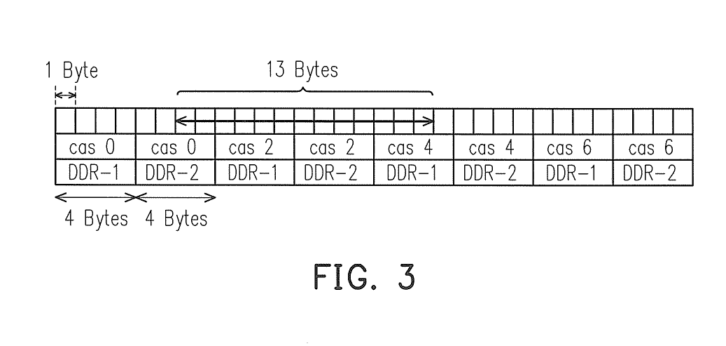

FIG. 3 is a diagram of the data access apparatus 200 accessing a single line in the first memory 201 and the second memory 203. Referring to FIGS. 2 and 3, take H.264 video codec specification for example, the motion compensation technology is often catching 13-byte data in horizontal lines during the process of decoding the digital images. When the start position of the motion vector does not align with the width of the data bus for the external memories (i.e. the two 16-bit DDRs), in the worse case, the memory controller should read 24-byte data in the external memories so as to obtain the necessary 13-byte data in horizontal lines. In this case, not only the memory bandwidth would be consumed mostly, but also the memory controller should spend three clock cycles to read out completely.

However, the data access apparatus 200 of the present embodiment merely spends two clock cycles to obtain 13-byte data in horizontal lines by sending different CAS signals, the first address signals Addr1[5:1] and the second address signals Addr2[5:1]. Accordingly, not only the memory bandwidth can be saved, but also the time of reading from the memory controller 205 to the first memory 201 and the second memory 203 can be reduced, so as to promote the utilization.

Of course, the above embodiment merely illustrates that the data access apparatus 200 reads the data of a single line in the first memory 201 and the second memory 203. Below, the other examples would be illustrated for explaining to the one person having ordinary skilled in the art.

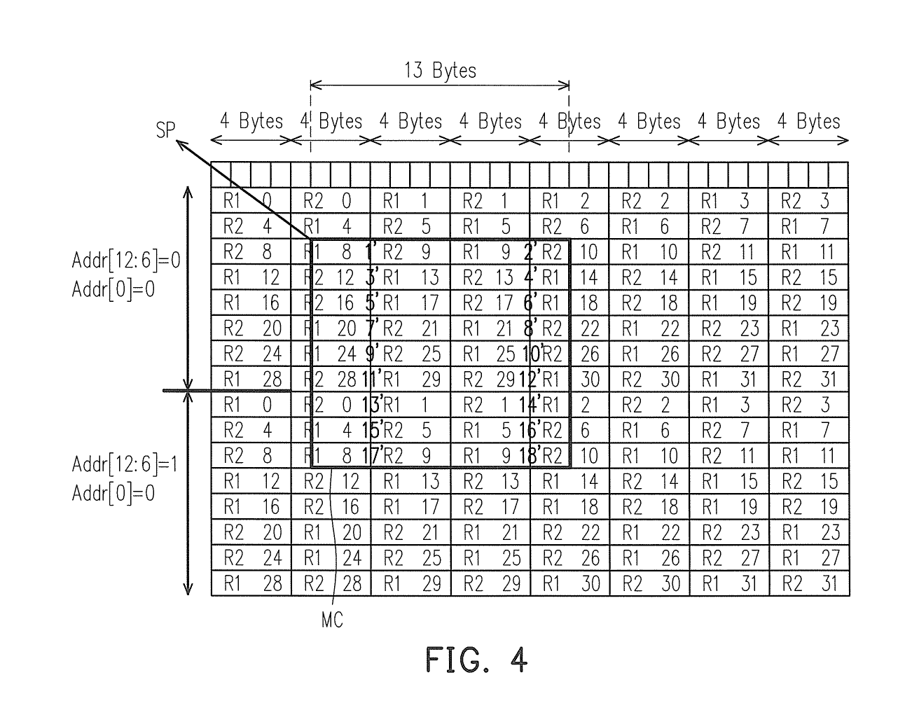

FIG. 4 is a diagram of the data access apparatus 200 accessing multi-columns and multi-rows in the first memory 201 and the second memory 203 according to an embodiment of the present invention. Referring to FIGS. 2 and 4, as shown in FIG. 4, the dynamic range of the motion compensation is 13*9, and the start position SP of the motion vector does not align with the width of the data bus of the first memory 201 and the second memory 203. Therefore, if using the conventional structure of memory controller, it should read 24-byte data from the two external memories with nine times, and further should spend 27 clock cycles to read out the data in the range of the motion compensation completely.

However, the memory controller 205 of the data access apparatus 200 in the present embodiment merely spends 18 clock cycles to read out the data in the range of the motion compensation completely by sending different CAS signal, the first address signals Addr1[5:1] and the second address signals Addr2[5:1]. In the present embodiment, the marks 1′-18′ in the thick frame MC are a reading sequence of the memory controller 205. R1 represents the first memory 201, and R2 represents the second memory 203. The numerals 1˜31 marked after R1 and R2 are respectively an address defined by the first address signals Addr1[5:1] and the second address signals Addr2 [5:1].

Furthermore, as long as the range of the motion compensation is getting bigger and bigger, the memory bandwidth and the memory access time respectively saved and reduced by the present embodiment are substantially better than the conventional. It should be noted that since the number of the first address signals Addr1[5:1] and the number of the second address signals Addr2[5:1] is five, so that the dynamic range of the first memory 201 and the second memory 203 accessed by the memory controller 205 during a clock cycle is 256-byte (2⁵*8). Namely, the region has 64-pixel*4-line. Accordingly, the memory controller 205 would arbitrarily access the data with different addresses in the first memory 201 and the second memory 203 according to the dynamic range.

To let the memory controller 205 can arbitrarily access the data with different addresses in the first memory 201 and the second memory 203 during a clock cycle, the first memory 201 and the second memory 203 should respectively store the neighbor data of an image in the present embodiment, as shown in FIG. 4.

Accordingly, the memory controller 205 would read the data with different addresses and which are neighbor in the first memory 201 and the second memory 203 at the same time. For example, R1 8 and R2 9, R1 9 and R2 10 . . . etc. (the way 1). In addition, the memory controller 205 further would read the data with different addresses and which are not neighbor in the first memory 201 and the second memory 203 at the same time. For example, R1 8 and R2 13, R2 9 and R1 10 . . . etc. (the way 2). In other words, the memory controller 205 may completely read out all of the data in the range of the motion compensation by the ways 1 and/or 2 during 18 clock cycles.

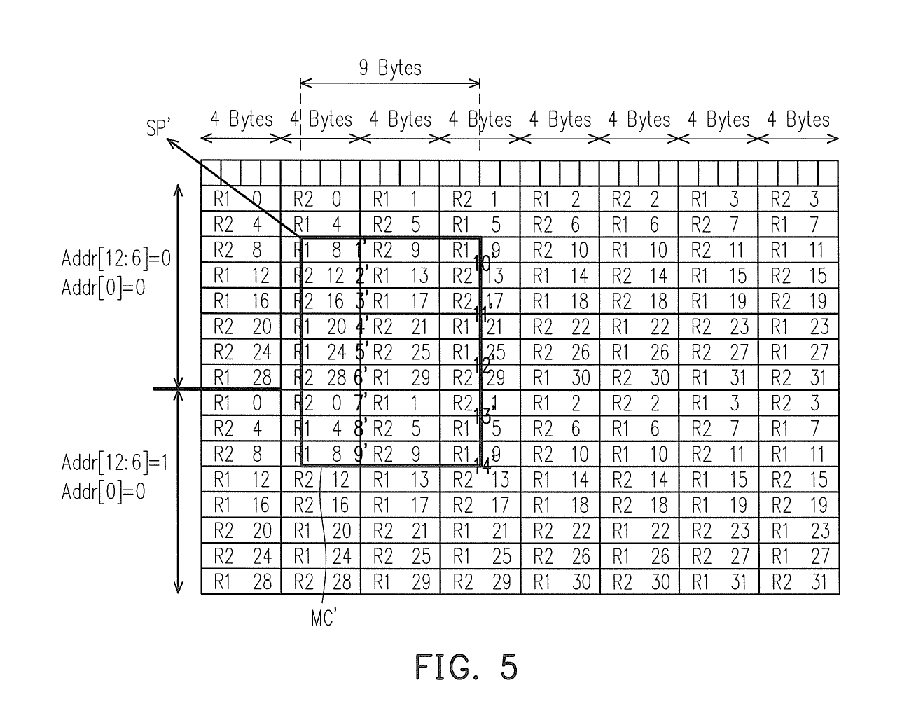

FIG. 5 is a diagram of the data access apparatus 200 accessing multi-columns and multi-rows in the first memory 201 and the second memory 203 according to an another embodiment of the present invention. As shown in FIG. 5, the range of the motion compensation is 9*9, and the start position SP′ of the motion vector does not align with the width of the data bus of the first memory 201 and the second memory 203. Therefore, if using the conventional structure of memory controller, it should read 16-byte data in the two external memories at nine times, and further should spend 18 clock cycles to read out the data in the range of the motion compensation completely.

However, the memory controller 205 of the data access apparatus 200 in the present embodiment merely needs 14 clock cycles to read out the data in the range of the motion compensation completely by sending different CAS signal, the first address signals Addr1[5:1] and the second address signals Addr2[5:1]. In the present embodiment, the marks 1′˜14′ in the thick frame MC′ are a reading sequence of the memory controller 205. R1 represents the first memory 201, and R2 represents the second memory 203. The numerals 1˜31 marked after R1 and R2 are respectively an address defined by the first address signals Addr1[5:1] and the second address signals Addr2[5:1].

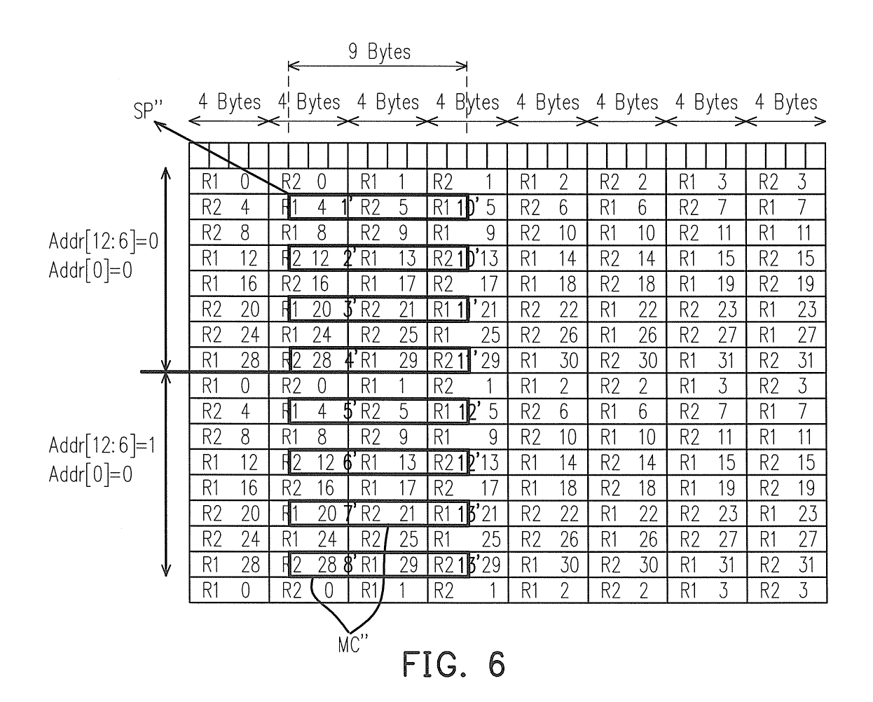

Besides, the range of the motion compensation in the above embodiments is a compact and whole region, such as the thick frame MC which is shown in FIG. 3 and the thick frame MC′ which is shown in FIG. 4, but the present invention is not limited thereto. In the other embodiment of the present invention, the range of the motion compensation (for example, the thick frames MC″) may be dispersed as shown in FIG. 6.

From the above, not only the data access apparatus 200 of the present invention could arbitrarily read the data of the first memory 201 and the second memory 203 with horizontal access, but also could arbitrarily read the data of the first memory 201 and the second memory 203 with vertical access. Accordingly, the data access apparatus 200 of the present embodiment could be cooperated with any one of current video codec technology, for example, H.264 video codec technology, MPEG-2 HD video codec technology, or VC-1 video codec technology, for achieving the purpose of saving the memory bandwidth and reducing the time of accessing from the memory controller 205 to the first memory 201 and the second memory 203 during process of encoding/decoding the digital images.

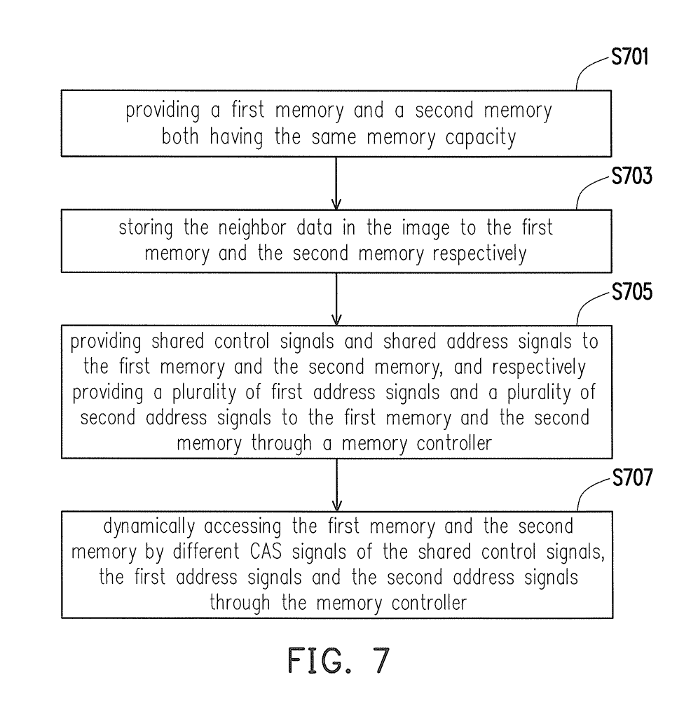

FIG. 7 is a flow chart of a data access method according to an embodiment of the present invention. Referring to FIG. 7, the data access method of the present embodiment is suitable for accessing data of an image, and includes the following steps of providing a first memory and a second memory both having the same memory capacity (in step S701), wherein the first memory and the second memory may, for example, the SDRAM, DDR, DDR2, or DDR3.

Next, storing the neighbor data of the image to the first memory and the second memory respectively (in step S703), such as shown in FIG. 4, but not limited thereto; and then providing shared control signals and shared address signals to the first memory and the second memory, and respectively providing a plurality of first address signals and a plurality of second address signals to the first memory and the second memory through a memory controller (in step S705), wherein the shared control signals includes RAS, CAS and WE signals.

Finally, dynamically accessing the first memory and the second memory by different CAS signals of the shared control signals, the first address signals and the second address signals through the memory controller (in step S707). In the present embodiment, the number of the first address signals is equal to the number of the second address signals, and the number of the first address signals and the number of the second address signals determine that the memory controller accesses a dynamic range of the first memory and the second memory during a clock cycle. Accordingly, the memory controller arbitrarily accesses the data with different addresses in the first memory and the second memory according to the dynamic range.

In addition, the data access method of the present embodiment could be cooperated with any one of current video codec technology, for example, H.264 video codec technology, MPEG-2 HD video codec technology, or VC-1 video codec technology, for achieving the purpose of saving the memory bandwidth and reducing the time of accessing from the memory controller to the first memory and the second memory during process of encoding/decoding the digital images.

In summary, the data access of the present invention would let two memories, which are used for increasing the memory bandwidth, have its own address signals rather than share all of the address signals in conventional. Moreover, the neighbor data of an image would further be respectively stored in the different memories, such that the memory controller could arbitrarily access the data with different addresses from the different memories by the dynamic range. Therefore, the data access of the present invention cooperate with any one of current video codec technology, the problem of wasting the memory bandwidth as prior art could be resolved, and then the time of accessing from the memory controller to the memories could be reduced.

It will be apparent to those skills in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A data access apparatus for accessing data of an image, the data access apparatus comprising:
a first memory;
a second memory, wherein memory capacity of the first memory and the second memory is the same, and the neighbor data of the image are respectively stored in the first memory and the second memory; and
a memory controller, coupled to the first memory and the second memory, for providing control signals and address signals to the first memory and the second memory together, and respectively providing a plurality of first address signals and a plurality of second address signals to the first memory and the second memory,
wherein when the data access apparatus adopts a motion compensation and a start position of motion vector does not align with a width of a data bus of the first memory and the second memory, the data access apparatus sends different column address strobe (CAS) signals from the control signals, the first address signals and the second address signals through the memory controller to dynamically access the first memory and the second memory.

2. The data access apparatus according to claim 1, wherein the number of the first address signals is equal to the number of the second address signals.

3. The data access apparatus according to claim 2, wherein a dynamic range relating to the memory controller accessing the first memory and the second memory during a clock cycle is determined by the number of the first address signals and the number of the second address signals.

4. The data access apparatus according to claim 3, wherein the memory controller accesses the data with different addresses in the first memory and the second memory according to the dynamic range.

5. The data access apparatus according to claim 1, wherein the control signals further comprise a row address strobe (RAS) signal and a write enable signal.

6. The data access apparatus according to claim 1, wherein the first memory and the second memory store alternately every M-byte data in the (4k+1)^{th} and the (4k+4)^{th} horizontal lines of the image in forward sequence, where M is a positive integer and k is a natural number.

7. The data access apparatus according to claim 6, wherein the first memory and the second memory store alternately every M-byte data in the (4k+2)^{th} and the (4k+3)^{th} horizontal lines of the image in backward sequence.

8. The data access apparatus according to claim 7, wherein the first memory further stores the M-byte data of the (4k+1)^{th} and the M-byte data of the (4k+4)^{th} in odd vertical lines of the image, and the second memory further stores the M-byte data of the (4k+2)^{th} and the M-byte data of the (4k+3)^{th} in even vertical lines of the image.

9. The data access apparatus according to claim 8, wherein the memory controller alternately reads the first memory and the second memory by the different CAS signals of the control signals, the first address signals and the second address signals.

10. A method for accessing data from an image, the method being applied to a data access system, and comprising:
providing a first memory and a second memory both having the same memory capacity to the data access system;
storing the neighbor data of the image to the first memory and the second memory respectively;
providing control signals and address signals to the first memory and the second memory together, and respectively providing a plurality of first address signals and a plurality of second address signals to the first memory and the second memory through a memory controller of the data access system; and
sending different column address strobe (CAS) signals from the control signals, the first address signals and the second address signals through the memory controller to dynamically access the first memory and the second memory when the data access system adopts a motion compensation and a start position of motion vector does not align with a width of a data bus of the first memory and the second memory.

11. The data access method according to claim 10, wherein the number of the first address signals is equal to the number of the second address signals.

12. The data access method according to claim 11, wherein a dynamic range relating to the memory controller accessing the first memory and the second memory during a clock cycle is determined by the number of the first address signals and the second signals.

13. The data access method according to claim 12, wherein the memory controller accesses the data with different addresses from the first memory and the second memory according to the dynamic range.

14. The data access method according to claim 10, wherein the shared control signals further comprise a row address strobe (RAS) signal and a write enable signal.

15. The data access method according to claim 10, wherein the first memory and the second memory store alternately every M-byte data in the (4k+1)^{th} and the (4k+4)^{th} horizontal lines of the image in forward sequence, where M is a positive integer and k is a natural number.

16. The data access method according to claim 15, wherein the first memory and the second memory store alternately every M-byte data in the (4k+2)^{th} and the (4k+3)^{th} horizontal lines of the image in backward sequence.

17. The data access method according to claim 16, wherein the first memory further stores the M-byte data of the (4k+1)^{th} and the M-byte data of the (4k+4)^{th} in odd vertical lines of the image, and the second memory further stores the M-byte data of the (4k+2)^{th} and the M-byte data of the (4k+3)^{th} in even vertical lines of the image.

18. The data access method according to claim 17, wherein the memory controller alternately reads the first memory and the second memory by the different CAS signals of the control signals, the first address signals and the second address signals.
